(19) United States
(12) Patent Application Publication
(10) Pub. No.: US 2016/0339571 A1
(43) Pub. Date: Nov. 24, 2016

(54) LINEAR ACTUATOR LOCK RING SPREADER

(71) Applicants: Leonard Austin Hensel, Oswego, IL (US); Aaron Robert Dahl, Plainfield, IL (US); Matthew J. Waeltz, Naperville, IL (US)

(72) Inventors: Leonard Austin Hensel, Oswego, IL (US); Aaron Robert Dahl, Plainfield, IL (US); Matthew J. Waeltz, Naperville, IL (US)

(73) Assignee: GKN ARMSTRONG WHEELS, INC., Armstrong, IA (US)

(21) Appl. No.: 14/716,455

(22) Filed: May 19, 2015

(51) Int. Cl. B25B 27/00; B25B 27/20

(52) U.S. Cl. CPC B25B 27/0035; B25B 27/20

(57) ABSTRACT

A lock ring spreader is provided. In one aspect, the invention provides for a lock ring spreader that includes a linear actuator suitable for spreading lock rings associated with large wheel rims, for example wheel rims suitable for use with mining equipment. The lock ring spreader includes mounts that can be removably coupled to a lock ring, whereupon the distance between the mounts is increased to expand the lock ring and remove the lock ring from the wheel rim. The lock ring spreader may be remotely controlled.

### FIELD OF THE INVENTION

This invention generally relates to a lock ring spreader including a linear actuator. The lock ring spreader is particularly suitable for opening lock rings associated with large mining equipment.

### BACKGROUND OF THE INVENTION

The present invention is generally directed towards a lock ring spreader. More specifically, the present invention relates to lock ring spreaders incorporating a linear actuator and methods for installing and uninstalling lock rings.

Lock rings are used in a wide variety of applications. For example, lock rings may be used to axially restrain a tire and associated components that are mounted to a wheel rim. A typical lock ring is a split ring having two ends in close proximity. After the tire has been mounted to the rim, the lock ring is installed by expanding the circumference of the lock ring, that is, the ends are spread apart to enlarge the overall diameter of the lock ring. The expanded lock ring is then moved over the rim. The rim includes an annular gutter or recess that is sized to receive the lock ring. Once the lock ring is aligned with the annular gutter, it is then closed (i.e., the ends are allowed to spring back toward their natural position) so that the lock ring is seated in the annular gutter, is biased toward the rim, and is axially restrained on the rim. To uninstall the lock ring, the lock ring is opened, unseated from the gutter, and removed from the rim.

Lock rings can be sized for use with rims ranging from less than twelve inches to over sixty-four inches in diameter. Lock rings, especially those at the larger end of the spectrum, can require a substantial amount of force to spread apart the ends. Even with smaller lock rings, other factors make it challenging to quickly and easily install and uninstall lock rings. Ergonomics of the installation can present impediments to manipulating the lock ring. For instance, installation and removal is often performed in the field (e.g., at a work site, such as a remote mine) and is subject to the current conditions (e.g., extreme temperatures, rain, etc.). In addition, those manipulating the lock ring are typically wearing thick gloves and often must maneuver the lock ring within a relatively limited envelope (e.g., larger tires may be mounted/dismounted while the rim remains bolted to the vehicle). Economic factors further drive a desire for efficient wheel repair because an idle machine, such as a dump truck having a capacity exceeding three hundred and fifty tons, has a substantial cost associated with each minute of unproductive downtime.

Accordingly, a need exists for a device and method for efficient installation and removal of lock rings.

### BRIEF SUMMARY OF THE INVENTION

In one aspect, the invention provides a lock ring spreader. The lock ring spreader includes a first mount and a second mount. The mounts are configured to be removably coupled to a wheel rim lock ring. The lock ring spreader also includes a linear actuator with a stationary end and a traveling end. The stationary end of the linear actuator is coupled to the first mount, and the traveling end is coupled to the second mount. The linear actuator may be operated to apply a force to the second mount with respect to the first mount to translate the second mount with respect to the first mount.

The lock ring spreader may include at least one guide rod. The lock ring spreader may also include a rechargeable battery. The lock ring spreader may further include a wireless control circuit.

In another aspect, the present invention provides a method for removing a lock ring from a wheel rim. The method includes the step of providing a linear actuator. The linear actuator includes a stationary end coupled to a first mount, and a traveling end coupled to a second mount. The method further includes the step of providing a lock ring. The lock ring includes a first end and a second end that are separated by a relaxed distance. The first mount is coupled to the first end, and the second mount is coupled to the second end. The linear actuator is operated to increase the separation between the first end and second end to an expanded distance greater than the relaxed distance.

The method may include the step of sending a wireless signal to operate the lock ring spreader. The method may also include the step of mounting the lock ring on a wheel rim or removing the lock ring from a wheel rim.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a front isometric view of a lock ring spreader of the present invention in a closed position.

FIG. 2 is a rear isometric view of a lock ring spreader of the present invention in a closed position.

FIG. 3 is a front isometric view of a lock ring spreader of the present invention in an open position.

FIG. 4 is a rear isometric view of a lock ring spreader of the present invention in an open position.

FIG. 5 is an isometric view of an exemplary wheel assembly including a lock ring.

FIG. 6 is a detail view of the exemplary wheel assembly circumscribed by arc 6-6 shown in FIG. 5.

FIG. 7 is a partial cross-sectional view along line 7-7 shown in FIG. 6.

FIG. 8 is an isometric view of an exemplary lock ring.

FIG. 9 is a detail view of the exemplary wheel assembly circumscribed by arc 9-9 shown in FIG. 8.

FIG. 10 is a view of an exemplary lock ring spreader coupled to a lock ring.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

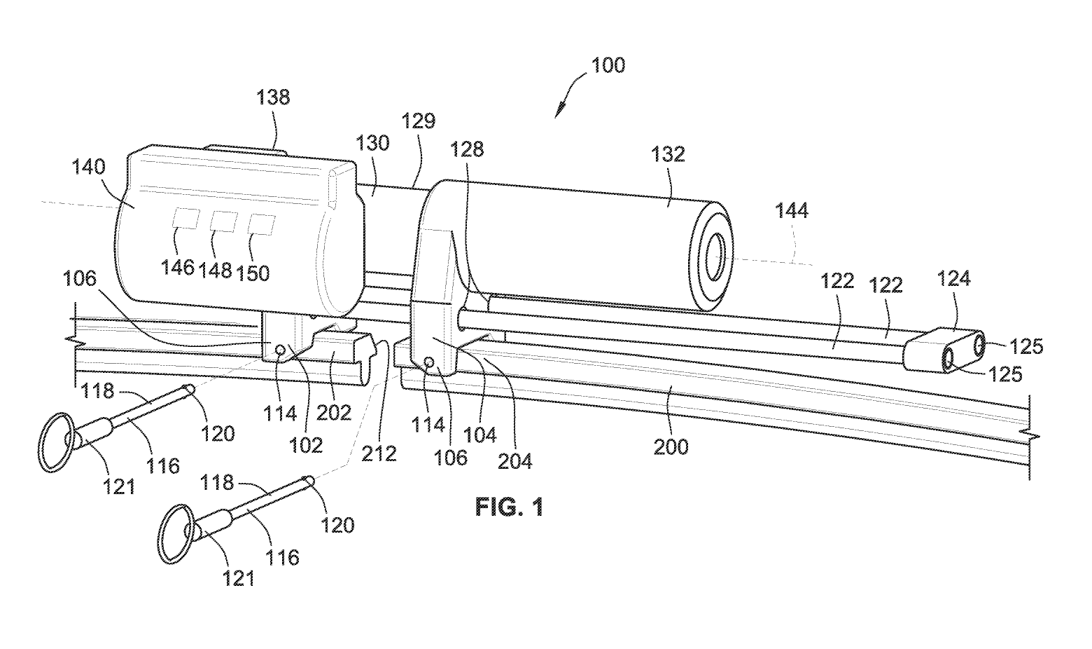

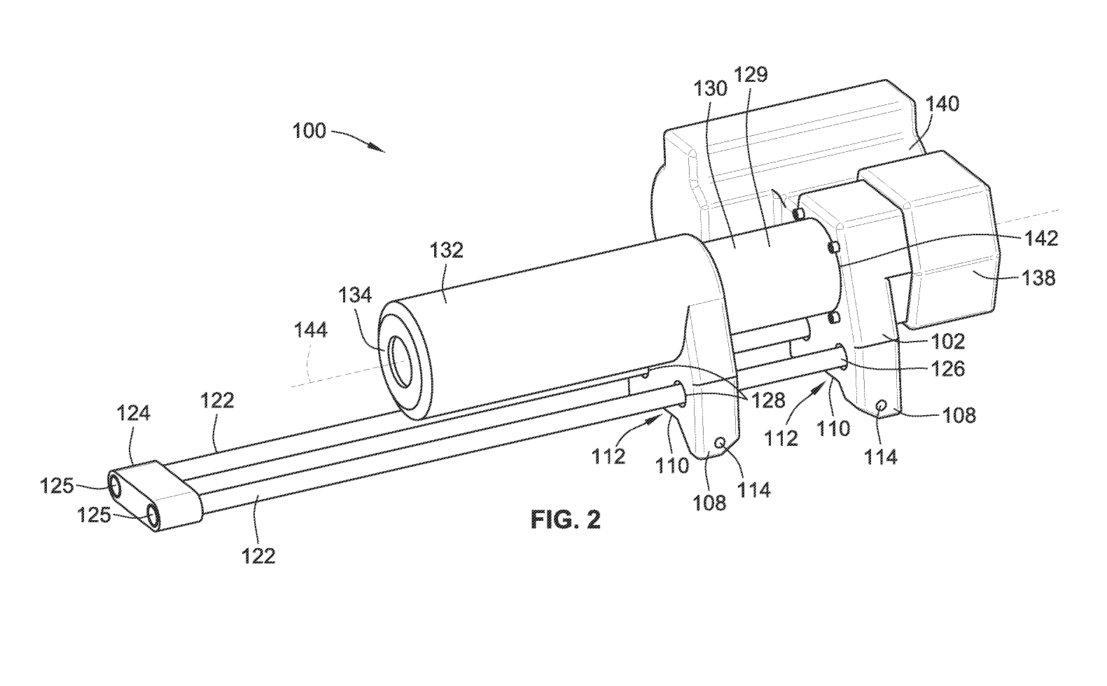

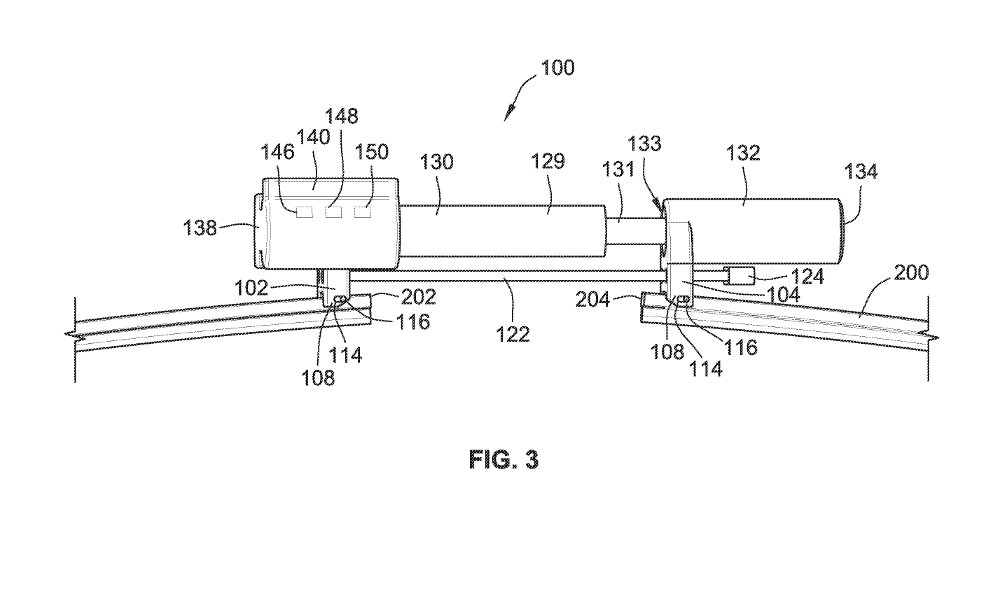

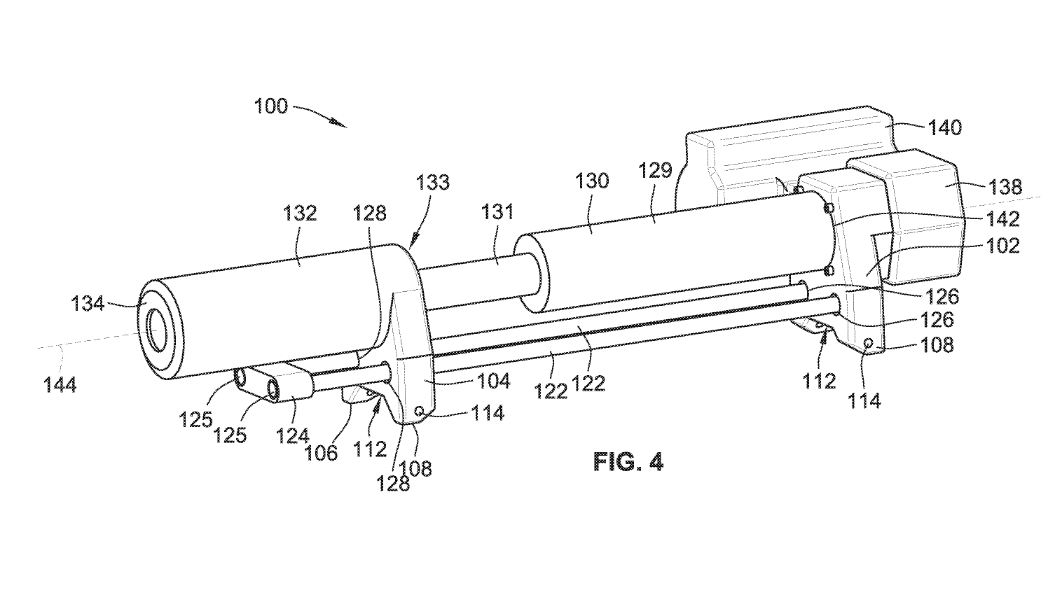

Referring to FIGS. 1-4, a lock ring spreader 100 is shown. The lock ring spreader 100 can be mounted to a lock ring 200 and used to open and close the lock ring 200. Specifically, when the lock ring spreader 100 is moved from a closed position (shown in FIGS. 1 and 2) to an extended position (shown in FIGS. 3 and 4), the lock ring 200 is correspondingly expanded from a closed position to an open position at which the interior diameter of the lock ring 200 is increased. The lock ring 200 is then more easily positioned over a rim of a wheel assembly and aligned with an annular gutter formed in the rim. With the lock ring 200 in position with respect to the wheel assembly, the lock ring spreader 100 is moved to the closed position and the lock ring 200 springs back toward its natural position. As the lock ring relaxes towards its natural position, it is seated in the annular gutter to axially restrain a tire on the rim.

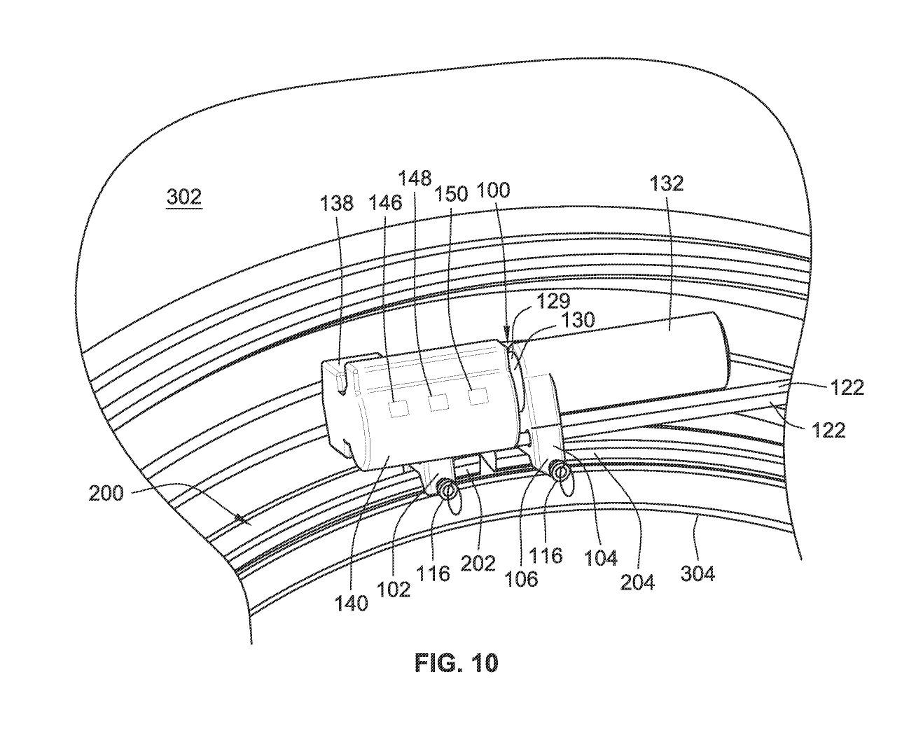

The lock ring spreader 100 is secured or mounted to the lock ring 200 by a first mount 102 and a second mount 104. Mounts 102, 104 each include a front leg 106 and a rear leg 108 that are connected by a bridge 110. An underside of each mount 102, 104 defines a generally U-shaped recess 112 in mounts 102,104. In the embodiment shown, legs 108 are provided with a taper 109 from the bridge 110 so that the recess 112 is configured to conform to the contours of the lock ring 200, for example slanting portion 212 of lock ring 200. In other embodiments, the recess 112 and legs 106, 108 may be contoured to engage the specific profile of a mating lock ring. As best shown in FIG. 10, the lock ring spreader 100 is configured to be coupled to the lock ring 200 while the lock ring 200 is mounted on a wheel rim 304.

Each leg 106, 108 further includes a pair of aligned, transverse holes 114. The holes 114 are positioned beneath the bridge 110 and are each configured to receive a mounting pin 116. Specifically, transverse holes 114 are aligned with openings 206, 208 (best shown in FIG. 9) near the ends 202, 204 of lock ring 200. The shaft 118 of each mounting pin 116 is inserted into a hole 114 and through one of openings 206, 208 until tip 120 of the mounting pin 116 is near one of the rear legs 108, and head 121 of mounting pin 116 is near one of the front legs 106, thereby securing mounts 102, 104 to respective ends 202, 204 of lock ring 200 (as shown in FIG. 10). Mounting pins 116 can include a spring-loaded ball that protrudes radially outward from the shaft 118 so that the ball can retract into the shaft 118 when sufficient axial force is applied to move the mounting pin 116 into the holes 114. The ball also inhibits the mounting pin 116 from being removed from the holes 114 without sufficient force. While the mounting pins 116 provide for convenient mounting and dismounting, the first mount 102 and the second mount 104, in other forms, can be bolted or otherwise secured to the lock ring 200.

A linear actuator 129 is provided in lock ring spreader 100 having a longitudinal axis 144. When lock ring spreader 100 is coupled to a lock ring 200 as described above, longitudinal axis 144 is oriented such that it is generally parallel to a tangent line of the circumference of lock ring 200. Linear actuator 129 includes a fixed cover 130 and a sliding rod 131, wherein sliding rod 131 may be translated with respect to fixed cover 130 along the direction of longitudinal axis 144, thereby increasing or reducing the length of linear actuator 129 in the direction parallel to longitudinal axis 144. Fixed cover 130 is coupled to stationary mount 102 at stationary end 142. Moveable mount 104 includes a cylindrical wall 132 defining an internal cylindrical barrel 133. Sliding tube 131 is coupled to moveable mount 104 at moveable end 134. Fixed cover 130 is received in cylindrical barrel 133 when linear actuator 129 is in a retracted condition, as shown in FIGS. 1 and 3.

Additionally, one or more guide rods 122 may be provided on lock ring spreader 100. The one or more guide rods 122 are generally cylindrical with a longitudinal axis parallel to the longitudinal axis 144 of linear actuator 129. Guide rods 122 allow translation of mount 104 with respect to mount 102 in a direction parallel to longitudinal axis 144 while preventing rotation of mount 104 around the longitudinal axis 144 of linear actuator 129. In a preferred embodiment, lock ring spreader is provided with two guide rods 122. In the embodiment shown, fixed ends 126 guide rods 122 are coupled to stationary mount 102. Moveable mount 104 is provided with cylindrical apertures 128 extending through mount 104. Apertures 128 may contain a bushing and slidingly receive guide rods 122, thereby allowing moveable mount 104 to slide along guide rods 122 in a direction parallel to longitudinal axis 144 when a force is imparted to moveable mount 104 by linear actuator 129. A stop 124 may be provided at the distal end 125 of guide rods 122 to couple the ends of guide rods 122. Stop 124 may optionally adjustable to limit the throw distance (i.e., how much the mounts 102, 104 spread apart during operation of the lock ring spreader 100). Stop 124 may optionally be provided with a cut-out switch preventing further extension of linear actuator 129 when moveable mount is translated to a position proximate to stop 124. It is generally understood that the labels “stationary” and “moveable” are used to indicate relative motion of mounts 102, 104 and associated components, and that alternate configurations of the linear actuator lock ring spreader may be used. For example, guide rods 122 may alternatively be fixed with respect to moveable mount 104 and extend through apertures provided in stationary mount 102.

In a preferred embodiment, linear actuator 129 is an electro-mechanical rod-style linear actuator which converts a rotary motion to linear movement. Specifically, the linear actuator may be a traveling nut linear actuator comprising two housings, one housing carrying a fixed nut and another housing carrying a shaft with a thread, the shaft with the thread threadingly engaging the nut such that during rotation of the shaft with respect to the nut, linear movement of the housings with respect to each other is obtained. In other embodiments, linear actuator 129 can be a hydraulic or pneumatic actuator.

As shown in FIGS. 1-4, linear actuator 129 of lock ring spreader 100 is provided with a motor 138, shown as electric motor 138. In some embodiments, electric motor 138 may directly drive a threaded shaft of a linear actuator 129. In other embodiments, motor 129 may include reduction gearing to provide a desired torque to linear actuator 129. Additionally, electric motor 138 is coupled to a source of electrical energy, shown in FIGS. 1-4 as battery pack 140. In a preferred embodiment, battery pack 140 is a rechargeable battery pack having battery cells employing a lithium-ion, nickel-cadmium, or other rechargeable cell chemistry. The battery pack 140 may be removably affixed to the lock ring spreader 100, or the housing of battery pack 140 may be integrally attached to lock ring spreader 100. Alternatively, battery pack 140 may be configured to house individual battery cells, whether rechargeable or disposable. In still other embodiments, motor 138 may be plugged into an electrical power source external to lock ring spreader 100. In still other embodiments, motor 138 may be a pneumatic motor powered by an external source of compressed air. In some embodiments, linear actuator 129 may additionally be provided with a manual drive interface (bolt head, socket recess, etc.) to manually operate the linear actuator in the event of power failure.

When extending or retracting, linear actuator 129 supplies a force parallel to longitudinal axis 144 of linear actuator 130, thereby translating moveable mount 104 with respect to stationary mount 102 and increasing or decreasing the distance between mounts 102, 104 in the direction parallel to longitudinal axis 144. When lock ring 200 is pinned to mounts 102, 104 of lock ring spreader 100 by mounting pins 116, extension and retraction of linear actuator 129 imparts a force to ends 102, 104 of lock ring 100, thereby expanding or contracting the gap 214 between ends 102, 104 of lock ring 100.

In a typical embodiment, linear actuator 129 applies a force of at least 100 lbs in the direction parallel to longitudinal axis 144 in applied mounts 102, 104, and thereby provides a similar force to ends 202, 204 of lock ring 200. In a typical embodiment, a force of about 200 to 300 lbs in the direction parallel to longitudinal axis 144 is applied to separate ends 202, 204 of lock ring 200. In some embodiments, linear actuator 129 of lock ring spreader 100 may be selected to expand the distance between mounts 102, 104 and lock ring ends 202, 204 at a rate of at least ½ inch per minute. In more preferred embodiments, linear actuator 129 of lock ring spreader 100 may be configured to expand the distance between mounts 102, 104 and lock ring ends 202, 204 at a rate of between about 1 inch to about 12 inches per minute. In typical embodiments suitable for lock ring diameters of 50 inches or more, linear actuator 129 of lock ring spreader 100 may be configured to expand the distance between mounts 102, 104 and lock ring ends 202, 204 at a rate of between about 1 inch to about 3 inches per minute. In some embodiments, lock ring spreader 100 is configured to provide a throw distance of at least 1 inch. In more preferred embodiments, linear actuator 129 of lock ring spreader 100 may be configured to provide a throw distance of between about 2 inches and 12 inches. In typical embodiments suitable for lock ring diameters of 50 inches or more, linear actuator 129 of lock ring spreader 100 may be configured to provide a throw distance of between about 3 inches to 7 inches.

Operation of linear actuator 129 may be controlled by one or more buttons, shown as exemplary buttons 146, 148, 150. For example, button 146 may be configured to cause linear actuator 129 to extend, button 148 may be configured to cause linear actuator 129 to retract. In some embodiments, linear actuator 129 may be programmed to have a maximum throw distance appropriate for a specific lock ring diameter. In such an embodiment, button 150 may be configured to automatically select a maximum throw distance for lock ring spreader 100. As shown, buttons 146, 148, 150 are placed on battery pack 140. In other embodiments control buttons may be placed elsewhere on lock ring spreader 100. Lock ring spreader 100 may be provided with more or fewer buttons, or other control inputs as is generally known in the art. For example, lock ring spreader 100 may be provided with a dial or slider to select operating parameters such as opening speed or throw distance. Lock ring spreader may also include a display or indicators (screen, LCD, LEDs, etc) to provide information to an operator. In other embodiments, lock ring spreader 100 may be provided with a control circuit to receive a control signal from a remote control device. The remote control device may be coupled to lock ring spreader 100 via a wired connection, or lock ring spreader 100 may be controlled wirelessly, for example by radio control or infrared control. In wireless radio embodiments, the control circuit may be configured to be operable with a wireless technology standard such as 2.4 GHz RC control, Bluetooth, and the like. In such embodiments, a wireless remote control unit configured to transmit a control signal (e.g., instructions to extend or retract the lock ring spreader) to the control circuit of the lock ring spreader may also be provided.

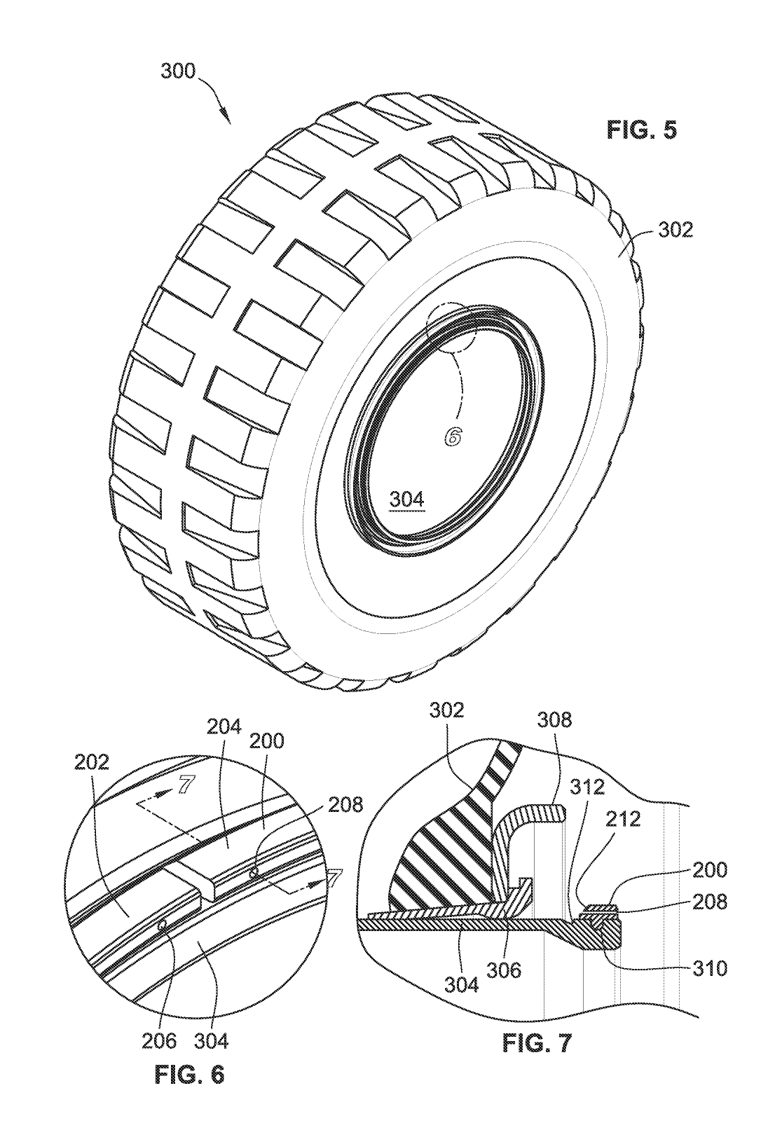

An example wheel assembly 300 is illustrated in FIGS. 5-7. The wheel assembly 300 includes a tire 302 that is mounted on a rim 304; the tire 302 is shown deflated prior to mounting or dismounting it from the rim 304. In operation, lock ring spreader 100 is pinned to lock ring 200 such that front legs 106 are distal from tire 302, and rear legs 108 are proximate to tire 302. As best shown in FIGS. 6 and 7, the tire 302 and associated bead seat band 306 and flange 308 are spaced inward and away from lock ring 200 to allow the mounts 102, 104 of the lock ring spreader 100 to be mounted near the ends 202, 204 of the lock ring 200. The lock ring 200 includes openings 206, 208 near the ends 202, 204 to allow the lock ring spreader 100 to be secured to the lock ring 200, as generally discussed above. Further separating the ends 202, 204 of the lock ring 200 (i.e., by actuating the lock ring spreader 100 to open and expand the lock ring 200) allows the lock ring 200 to be removed from the rim 304. Specifically, the lock ring 200 is spread apart to allow a contoured, radially inner protrusion 210 to be spaced apart and removed from a gutter 310 formed in the rim 304. An o-ring (not shown) is typically seated in an annular groove 312 also formed in the rim 304.

The lock ring 200 and the lock ring spreader 100 can be contoured and sized to meet various application-specific requirements. For example, the location of the openings 206, 208 in the lock ring 200 and the throw of lock ring spreader 100 can be optimized to ensure the successful and repeated installation and removal of the lock ring 200 to and from the rim 304. Specifically, the lock ring 200 and the lock ring spreader 100 are preferably configured such that the lock ring spreader 100 provides sufficient throw to easily remove the lock ring 200 from the rim 304 (i.e., unseat the radially inner protrusion 210 of lock ring 200 from the gutter 310 of rim 304) without plastically deforming any portion of the lock ring 200. Plastic deformation of the lock ring 200 is undesirable as it can reduce the effective spring force retaining the lock ring 200 and other components (i.e., the tire 302, the bead seat band 306, and the flange 308) on the rim 304.

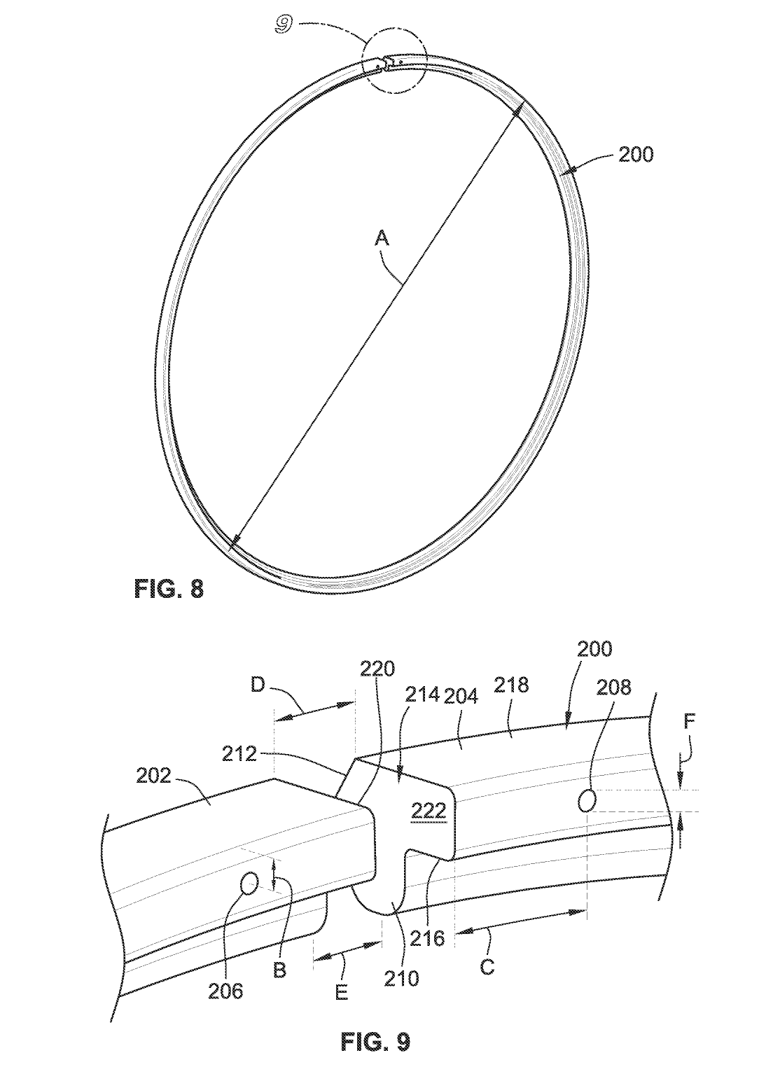

The specifics of an exemplary lock ring 200 are discussed with reference to FIGS. 8 and 9. The lock ring 200 is designed for use with a wheel rim having a nominal diameter of 57 inches. The interior diameter A (between inner surface 216 shown in FIG. 9) is approximately 54.9 inches as measured in a “natural” or an “unloaded” state (i.e., no external forces are applied to influence the relative position of the ends 202, 204). Each of the openings 206, 208 in the lock ring 200 is offset radially inward from an outer surface 218 a perpendicular distance B of approximately 0.42 inches and is spaced from a respective end face 220, 222 an arcuate distance C of approximately 1.75 inches. A wedge-shaped gap 214 is established between the end faces 220, 222 such that the end faces 220, 222 are spaced an arcuate distance D of approximately 0.64 inches at the radially outer edge of lock ring 200, and an arcuate distance E of approximately 0.58 inches at the radially inner edge of lock ring 200. Each of the openings 206, 208 has a diameter of approximately 0.31 inches. Generally, lock ring 200 may be sized to fit wheel rims of other sizes, including wheel rims having nominal diameters of 51 and 63 inches.

The relative dimensions, actuator force, throw length, and travel rate, mounting location, and other construction details of the linear actuator lock ring spreader concept can be varied depending on the particular application requirements. For instance, a longer linear actuator rod can be incorporated to increase the distance the mounts are separated when the lock ring spreader is in a fully extended state. In another example, a more powerful linear actuator with a lower extension rate can be employed to open larger and heavier lock rings.

The example linear actuator lock ring spreader is described in connection with exemplary lock rings for securing the lock ring on a wheel or rim to retain a tire on the rim. However, as one skilled in the art will appreciate when given the benefit of this disclosure, the linear actuator lock ring spreader concept can be adapted to engage other lock rings and associated bead seat band forms, such as the various lock rings manufactured by GKN Wheels Armstrong of Armstrong, Iowa. Furthermore, the structure, size, and construction of the linear actuator lock ring spreader can be adapted from the examples shown to accommodate specific application requirements (e.g., operating envelope restrictions, force requirements, cost constraints, etc.) without departing from the linear actuator lock ring spreader concept.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A lock ring spreader, comprising
a first mount configured to be removably coupled to a first end of a wheel rim lock ring;
a second mount configured to be removably coupled to a second end of the wheel rim lock ring; and
a linear actuator, wherein a stationary end of the linear actuator is coupled to the first mount and a traveling end of the linear actuator is coupled to the second mount;
wherein the linear actuator is operable to apply a force to the second mount with respect to the first mount and translate the second mount with respect to the first mount.

2. The lock ring spreader of claim 1, wherein the linear actuator is a traveling nut linear actuator comprising two housings, one housing carrying a nut and another housing carrying a shaft with a thread, the shaft with the thread threadingly engaging the nut such that during relative rotation therebetween linear reciprocation is achieved.

3. The lock ring spreader of claim 2, further comprising at least one guide rod extending generally parallel to the shaft and between the two housings for guiding linear movement of the linear actuator.

4. The lock ring spreader of claim 3, wherein at least two guide rods are provided in parallel relation with the linear actuator disposed laterally therebetween, each guide rod coupled to a first one of the housings and slidably mounted within bushings to a second one of the housings, and wherein free ends of the guide rods are secured together by a coupling.

5. The lock ring spreader of claim 1, further comprising a rechargeable battery electrically connected to the linear actuator for powering the linear actuator.

6. The lock ring spreader of claim 1, further comprising a wireless control circuit configured to receive a wireless control signal and operatively connected to the linear actuator to drive linear reciprocation thereof, and further comprising a wireless remote control unit adapted to communicate with the wireless control circuit.

7. The lock ring spreader of claim 1, wherein the linear actuator is configured to exert a force of at least 100 lb on the second mount with respect to the first mount.

8. The lock ring spreader of claim 1, wherein the linear actuator is configured to exert a force of between about 200 lb to 300 lb on the second mount with respect to the first mount.

9. The lock ring spreader of claim 1, wherein the linear actuator is configured to translate the second mount with respect to the first mount at a rate of about 1 inch to 3 inches per minute.

10. The lock ring spreader of claim 1, wherein the lock ring spreader has a throw distance of between about 3 inches to about 7 inches.

11. The lock ring spreader of claim 1, wherein the linear actuator further comprises an electric motor coupled to the linear actuator to rotate a shaft of the linear actuator such that linear reciprocation is achieved.

12. The lock ring spreader of claim 1, wherein the lock ring spreader further comprises a pneumatic motor coupled to the linear actuator to rotate a shaft of the linear actuator such that linear reciprocation is achieved.

13. The lock ring spreader of claim 1, wherein the linear actuator is a hydraulic linear actuator comprising two housings, one housing coupled to a cylinder and another housing carrying piston, the piston engaging the cylinder such that linear reciprocation is achieved when hydraulic pressure is introduced into the cylinder.

14. A method of spreading a lock ring, comprising the steps of:
providing a lock ring spreader, the lock ring spread including a first mount, a second mount, and a linear actuator;
providing a lock ring, the lock ring including a first end and a second end, the first end and second end being separated by a first distance;
coupling the first mount to the first end, and coupling the second mount to the second end; and
operating the linear actuator to increase the separation between the first end and the second end to an expanded distance greater than the first distance.

15. The method of claim 14, wherein the expanded distance is at least about 3 inches.

16. The method of claim 14, wherein the expanded distance is between about 3 inches to about 7 inches.

17. The method of claim 14, further comprising the step of sending a wireless signal to operate the linear actuator.

18. The method of claim 14, further comprising the step of mounting the lock ring on a wheel rim.

19. The method of claim 18, further comprising the steps of actuating the linear actuator to decrease the separation between the first end and second and removing the lock ring spreader from the lock ring.

20. The method of claim 14, further comprising the step of removing the lock ring from a wheel rim.
